(19) United States
(12) Patent Application Publication
(10) Pub. No.: US 2012/0194314 A1
(43) Pub. Date: Aug. 2, 2012

(54) LOW-PROFILE INDUCATOR AND ITS FABRICATION METHOD

(76) Inventor: Chia-Ping MO, Keelung City (TW)

(21) Appl. No.: 13/166,506

(22) Filed: Jun. 22, 2011

(30) Foreign Application Priority Data
Jan. 28, 2011 (TW) 100103361

(51) Int. Cl. H01F 5/00; H01F 41/00

(52) U.S. Cl. 336/200; 29/602.1

(57) ABSTRACT

A low-profile inductor includes
two flat substrates each flat substrate having opposing inner surface and outer surface, a set of metal wire conductors radially arranged in the inner surface, a connection contact located on each end of each metal wire conductor and a circuit layout arranged in the outer surface, a solder material set in between the flat substrates to electrically connect the connection contacts and the metal wire conductors of the flat substrates into two series, and a metal core bonded to the inner surface of each flat substrate with an adhesive and set between the metal wire conductors of the two flat substrates such that an induction zone is defined between the two flat substrates corresponding to the metal wire conductors to provide a continuous winding type metal magnetic coil inductive effect, enhancing rectifying and filtering performance.

This application claims the priority benefit of Taiwan patent application number 100103361 file on Jan. 28, 2011.

### BACKGROUND OF THE INVENTION

1. Field of the Invention

The present invention relates to electrical inductors and more particularly, to a low-profile inductor, which includes two flat substrates electrically arranged in parallel, and a metal core set between a set of radially arranged metal wire conductors at each of the two flat substrates to provide a continuous winding type metal magnetic coil inductive effect, facilitating fabrication and eliminating the drawback of complicated winding procedure of the fabrication of a prior art inductor using an enabled wire winding technique

2. Description of the Related Art

Following fast development of computer technology, many advanced, high-speed. Small-size electronic and electrical products have been created and have appeared on the market. These advanced electronic and electrical products have the common time-saving, labor-saving and high performance characteristics. Further, to adapt to improvement of new generation electronic and electrical products, the related control systems, circuit boards and components must be relatively improved. Nowadays, electronic products having light, thin, short and small characteristics have become the mainstream products in the market. In consequence, electronic component parts must have low profile and small size characteristics, saving circuit board space.

An inductor or choke is a passive electrical component commonly used in many different electronic products to store energy in a magnetic field created by the electric current passing through it. Typically an inductor, as shown in FIG. 8, is a conducting wire shaped as a coil B wound on a core A. The loops of the coil B help to create a strong magnetic field inside the coil. Due to the time-varying magnetic field inside the coil, a voltage is induced. Inductors are basic components used in electronics where current and voltage change with time, due to the ability of inductors to delay and reshape alternating currents. This design of inductor or choke is still not satisfactory in function due to the following drawbacks:
1. After winding of the coil B on the core A, the dimension is greatly increased. When used in a circuit board, the inductor occupies much circuit board space, affecting the circuit arrangement of the circuit board.
2. When winding an enameled wire on the core A to form the coil B, it is difficult to control the gap between each two adjacent loops of the coil B. Further, because the coil B is exposed to the outside, it tends to be scratched or damaged by an external object during installation or delivery, affecting the performance.
3. Winding an enabled wire on the core A to form the desired coil B must be done manually by labor, complicating the fabrication of the inductor and wasting much labor and time.

Therefore, it is desirable to provide an inductor that eliminates the drawbacks of the aforesaid prior art design.

### SUMMARY OF THE INVENTION

The present invention has been accomplished under the circumstances in view. It is one object of the present invention to provide a low-profile inductor, which has a low profile characteristic, saving much installation space. It is another object of the present invention to provide a low-profile inductor, which is suitable for mass production, saving much fabrication labor and time.

To achieve this and other objects of the present invention, a low-profile inductor comprises two symmetric flat substrates arranged in parallel, each flat substrate comprising opposing inner surface and outer surface, a set of metal wire conductors radially arranged in the inner surface, a connection contact located on each of two distal ends of each metal wire conductor and a circuit layout arranged in the outer surface, a solder material set in between the flat substrates to electrically connect the connection contacts and the metal wire conductors of the flat substrates in two series, and a metal core bonded to the inner surface of each of the two flat substrates with an adhesive and set between the metal wire conductors of the two flat substrates such that an induction zone is defined between the two flat substrates corresponding to the metal wire conductors to provide a continuous winding type metal magnetic coil inductive effect, enhancing rectifying and filtering performance.

Further, the solder material can be tin solder, solder balls, or silver glue. Further, the bonding technique employed to electrically connect the connection contacts and the metal wire conductors can be, for example, reflow soldering. Further, each flat substrate defines opposing input side and output side at the outer surface thereof opposite to the induction zone. The two initial ones and two last ones of the two electrically connected series of the connection contacts of the metal wire conductors in the induction zone at the inner surface of each of the two flat substrates are respectively electrically connected to input side and output side at the outer surfaces of the flat substrates.

Further, the outer surface of each of the two flat substrates is formed of a copper foil layer. After formation of the designed circuit layout, the copper foil layer of the outer surface of each of the two flat substrates is coated with an insulative resin layer, and then coated with a layer of green color photosensitive lacquer by means of screen printing, curtain coating or electrostatic spraying techniques, and then heat dried and then cooled down, and then radiated by ultraviolet rays in an UV exposure machine under the use of a patterned mask to polymerize the green color photosensitive lacquer. After polymerization of the green color photosensitive lacquer at the outer surface of each of the two flat substrates, apply sodium carbonate solution to remove the part of the coating that is not radiated by the ultraviolet rays. Thereafter, apply a high temperature heating process to cure the resin in the green color photosensitive lacquer. Thus, the circuit layout in the outer surface of each of the two flat substrates is well protected against oxidation or accidental short circuit during welding.

Further, the metal core is selected from the group of iron based, iron-nickel based and cobalt based non-crystalline alloys and iron based bulk nanocrystalline alloy, and made in one of the shapes of annular, rectangular, polygonal and multilateral open frames.

### BRIEF DESCRIPTION OF THE DRAWINGS

FIG. 1 is an oblique top elevational view of an inductor in accordance with the present invention.

FIG. 2 is an exploded view of the inductor in accordance with the present invention.

FIG. 3 corresponds to FIG. 2 when viewed from another angle.

FIG. 4 is a sectional side view of the inductor in accordance with the present invention.

FIG. 5 is an inductor fabrication flow according to the present invention.

FIG. 6 is a perspective view of the inductor in accordance with the present invention.

FIG. 7 is a perspective view of an alternate form of the inductor in accordance with the present invention.

FIG. 8 is an elevational view of an inductor according to the prior art.

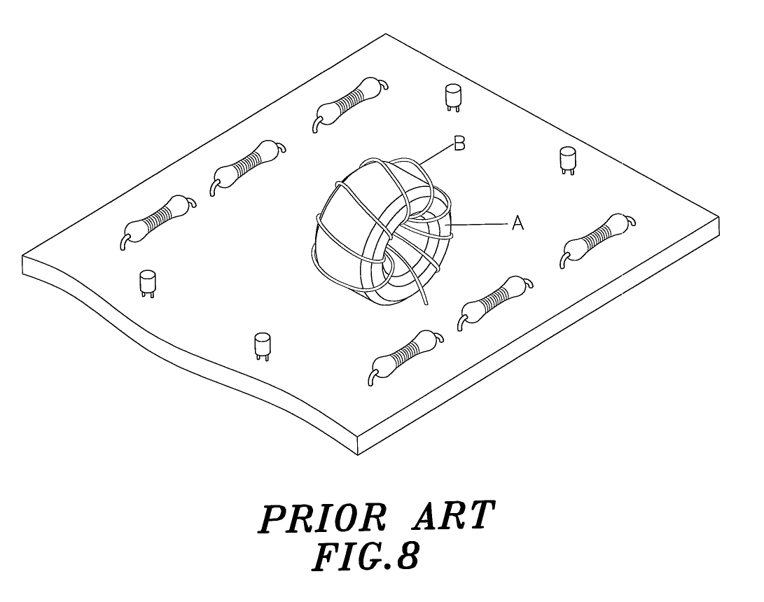

### DETAILED DESCRIPTION OF THE PREFERRED EMBODIMENT

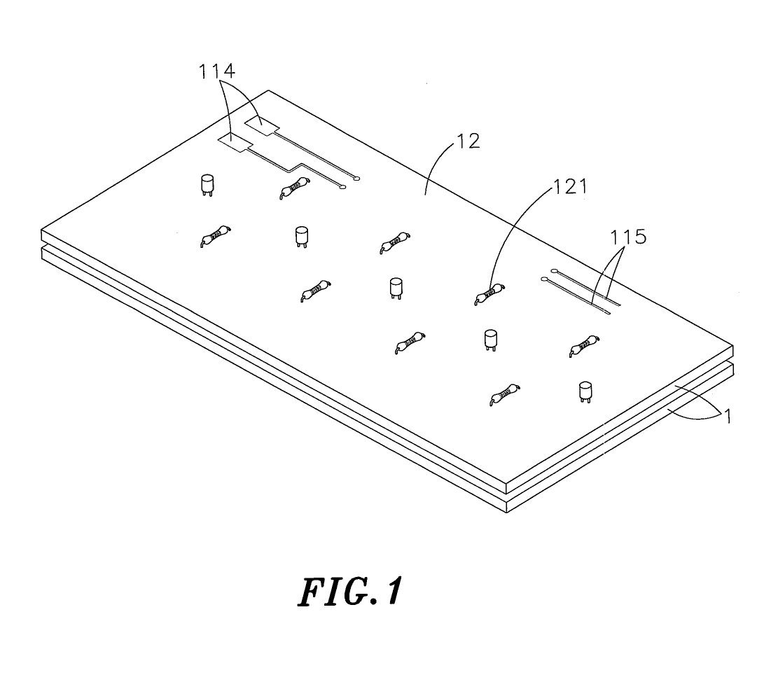

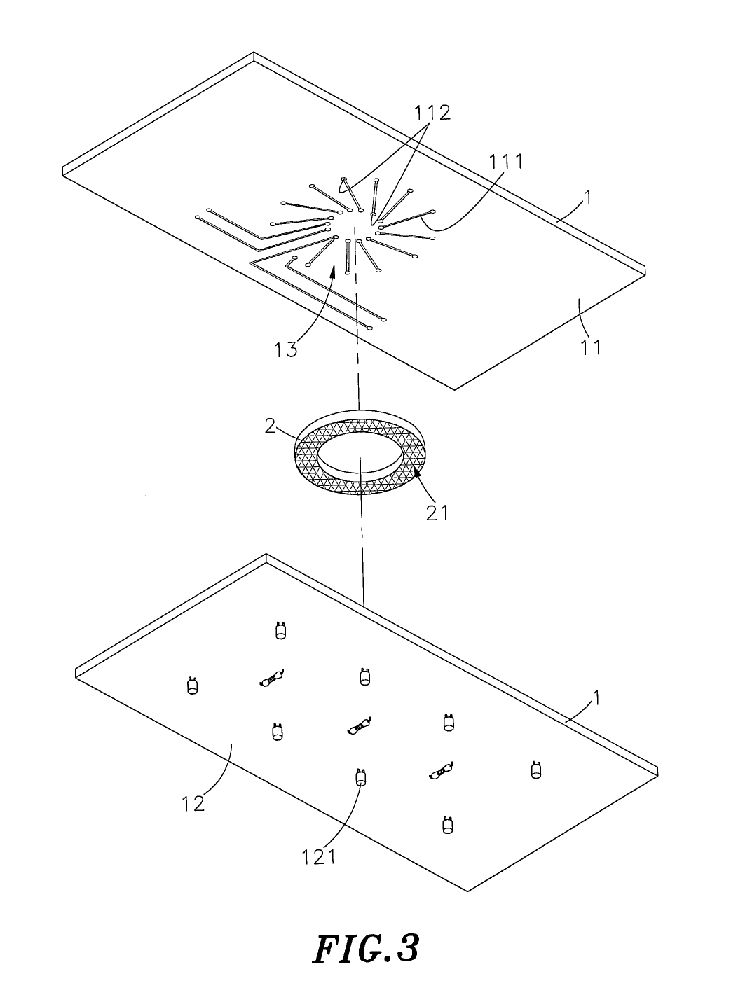

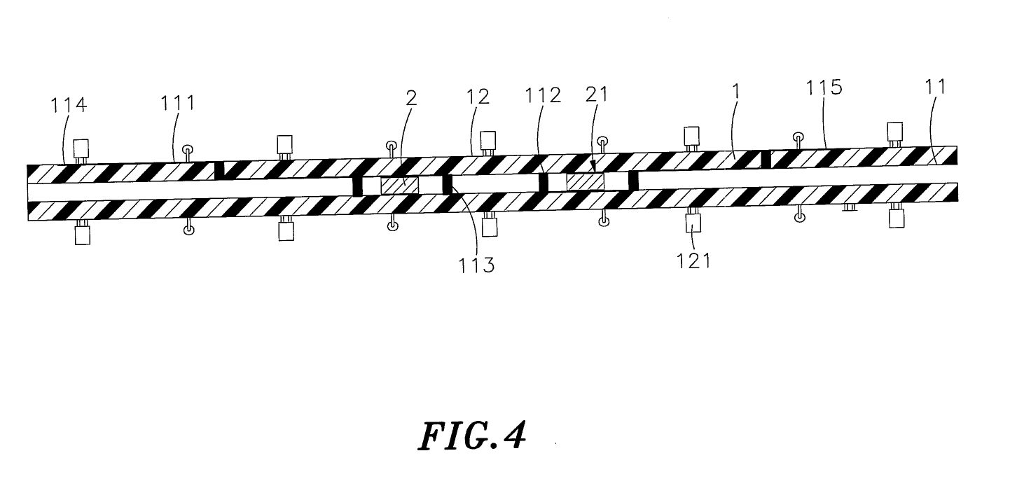

Referring to FIGS. 1-4, a low-profile inductor in accordance with the present invention is shown comprising two symmetric flat substrates 1 and at least one metal core 2.

Each flat substrate 1 has opposing inner surface 11 and outer surface 12. Metal wire conductors 111 are radially arranged at the center area of the inner surface 11 of each flat substrate 1, each having a connection contact 112 at each of the opposing ends thereof. The outer surface 12 of each flat substrate 1 provides a circuit layout having a filter function. The circuit layout is an electric loop consisting of different electronic components 121, forming an electrical loop.

Each metal core 2 is an annular non-crystalline metal core.

During installation of the inductor, the metal core 2 is set between the metal wire conductors 111 at the inner surfaces 11 of the flat substrates 1 and bonded thereto with an adhesive 21 (the adhesive can be coated on the metal wire conductors 111 at the inner surfaces 11 of the flat substrates 1 or the two opposing sides of the metal core 2). Thereafter, a solder material 113 is applied to electrically and alternatively connect the connection contacts 112 of the metal wire conductors 111 at the inner surfaces 11 of the flat substrates 1 into two series. After the two symmetric flat substrates 1 and the at least one metal core 2 are assembled to form an inductor, the two electrically connected series of the metal wire conductors 111 work with the metal core 2 to produce a continuous winding type metal magnetic coil inductive effect.

Further, the flat substrates 1 can be regular printed circuit boards or flexible circuit boards. The metal wire conductors 111 can be formed in the inner surfaces 11 of the flat substrates 1 by means of a mechanical process or photolithography technique. After formation of the metal wire conductors 111 in the inner surface 11 of each flat substrate 1, an induction zone 13 is defined between the copper foils at the two flat substrates 1 corresponding to the metal wire conductors 111. Further, two initial ones and two last ones of the two electrically connected series of the connection contacts 112 of the metal wire conductors 111 in the induction zone 13 at the inner surface 11 of each of the flat substrates 1 are respectively electrically connected to respective metal input contacts 114 and metal output contacts 115 at the outer surface 12 of the respective flat substrate 1.

Further, as stated above, the metal core 2 according to the present preferred embodiment is an annular non-crystalline metal core. The metal core 2 can be made by iron based, iron-nickel based or cobalt based non-crystalline alloy, or iron based bulk nanocrystalline alloy. The annular configuration is not a limitation. Alternatively, the metal core 2 can be made in the shape of a rectangular, polygonal or multilateral open frame.

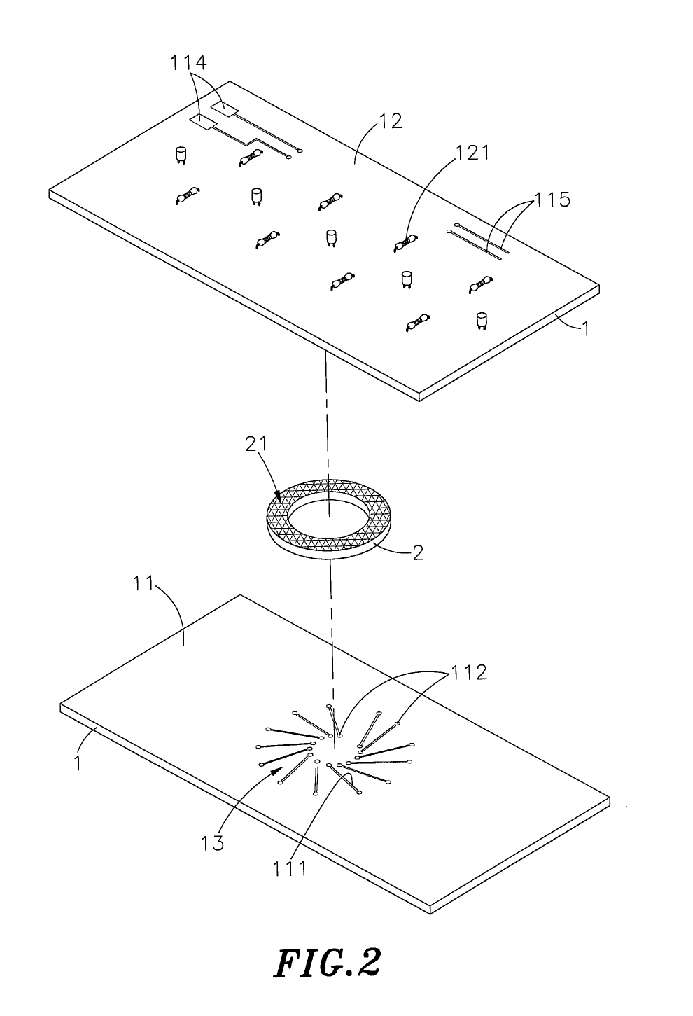

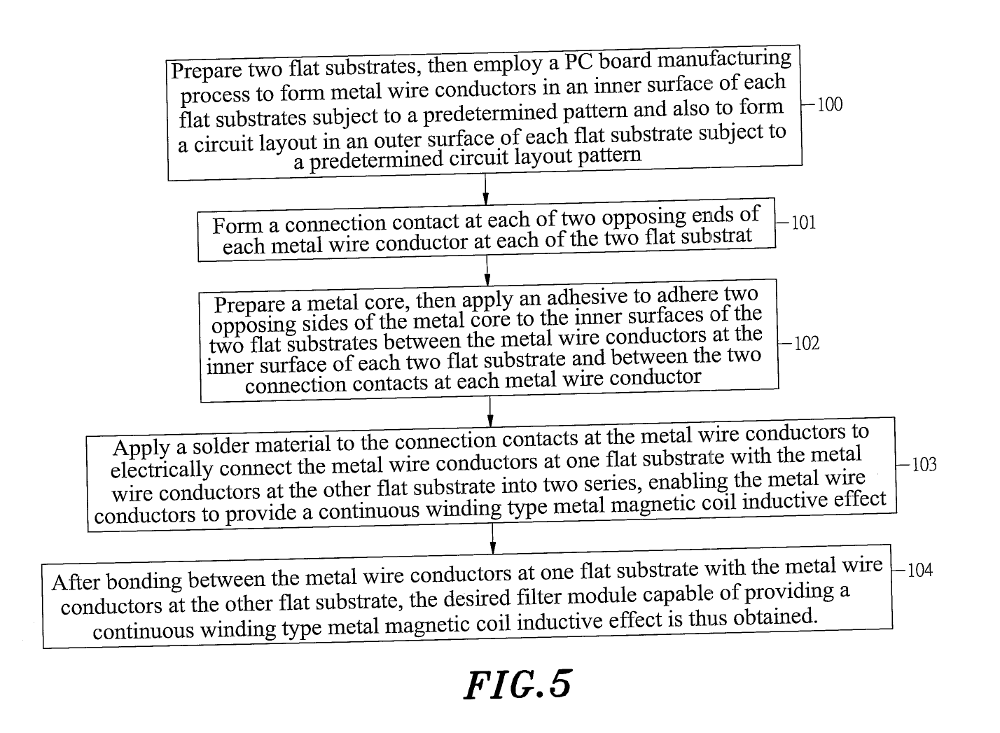

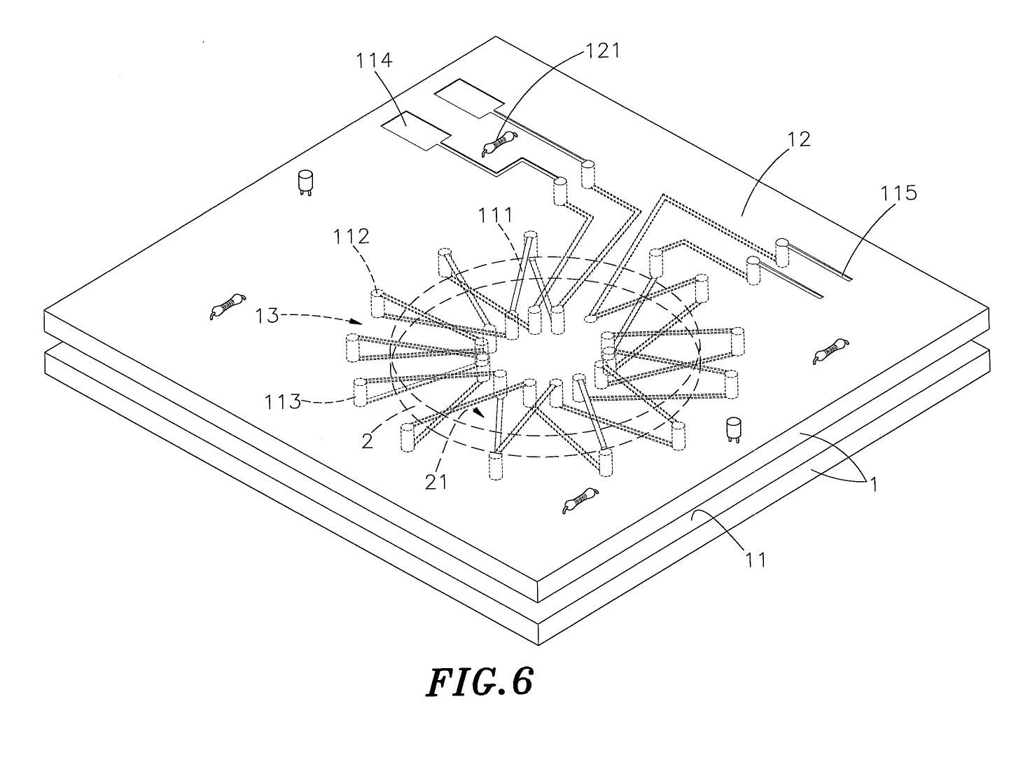

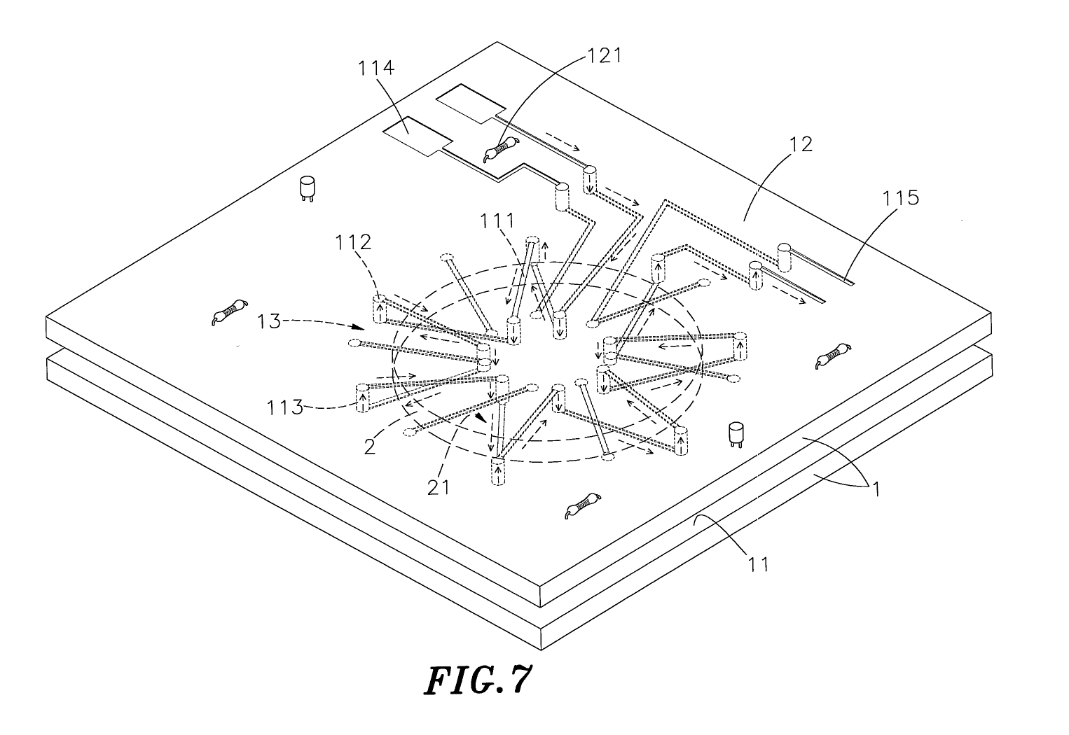

Referring to FIGS. 5-7 and FIG. 2, the inductor is made subject to the following manufacturing steps:

(100) Prepare two flat substrates 1 each having opposing inner surface 11 and outer surface 12, and then employ a PC board manufacturing process including hole drilling, image transfer, plating, etching, anti-soldering and/or surface treatment steps to form metal wire conductors 111 in the inner surface 11 of each of the flat substrates 1 subject to a predetermined pattern for enabling an induction zone 13 to be defined between the two flat substrates 1 corresponding to the metal wire conductors 111, and also to form a circuit layout consisting of different electronic components 121, metal input contacts 114 and metal output contacts 115 in the outer surface 12 of each flat substrate 1 subject to a predetermined circuit layout pattern.

(101) Form a connection contact 112 at each of the two opposing ends of each of the metal wire conductors 111 at each of the two flat substrates 1.

(102) Prepare a metal core 2, and then apply an adhesive 21 to adhere two opposing sides of the metal core 2 to the inner surfaces 11 of the two flat substrates 1 between the metal wire conductors 111 at the inner surface 11 of each of the two flat substrates 1 and between the two connection contacts 112 at each metal wire conductor 111.

(103) Apply a solder material 113 (solder paste, solder balls, silver glue) to the connection contacts 112 at the metal wire conductors 111 to electrically connect the metal wire conductors 111 at one flat substrate 1 with the metal wire conductors 111 at the other flat substrate 1 into two series, enabling the metal wire conductors 111 to provide a continuous winding type metal magnetic coil inductive effect.

(104) After bonding between the metal wire conductors 111 at one flat substrate 1 with the metal wire conductors 111 at the other flat substrate 1, the flat substrates 1 and the metal core 2 constitute a low-profile inductor capable of providing a continuous winding type metal magnetic coil inductive effect.

Further, the metal wire conductors 111 can be formed in the inner surface 11 of each of the flat substrates 1 subject to a predetermined pattern by means of screen printing, etching or electroplating technique so that an induction zone 13 can be defined between the two flat substrates 1 corresponding to the metal wire conductors 111. Further, the desired circuit layout with the related electronic components 121, metal input contacts 114 and metal output contacts 115 are formed in the outer surface 12 of each of the flat substrates 1 subject to a predetermined circuit layout patter. Further, the two initial ones and two last ones of the two electrically connected series of the connection contacts 112 of the metal wire conductors 111 are respectively electrically connected to respective metal input contacts 114 and metal output contacts 115 at the outer surfaces 12 of the flat substrates 1.

Further, the metal core 2 is set between the metal wire conductors 111 at the inner surfaces 11 of the flat substrates 1 and bonded thereto with an adhesive 21. The adhesive 21 can be coated on the metal wire conductors 111 at the inner surface 11 of each of the flat substrates 1 or the two opposing sides of the metal core 2. Further, the adhesive 21 is selected from the group of polymer adhesive, plastic resin glue, chloroprene phenolic adhesive and quick dry adhesive. Further, the metal core 2 is selected from the group of iron based, iron-nickel based and cobalt based non-crystalline alloys and iron based bulk nanocrystalline alloy. Further, the metal core 2 can be made in one of the shapes of annular, rectangular, polygonal and multilateral open frames.

Subject to the thin sheet design of the flat substrates 1 and the use of thin thickness metal core 2, the inductor has the characteristics of low profile, excellent induction and current rectification ability. For the advantage of space saving, the invention is practical for use in an electronic product having light, thin, short and small characteristics. When an electric current is guided through the metal input contacts 114 at one flat substrate 1, it goes through the connection contacts 112 at the metal wire conductors 111 and the induction zone 13 to the respective metal output contacts 115 for output to an external circuit for enabling inductance components to perform charging, discharging, rectifying and chocking operations stably. When an electric current goes through the filter components, the induced magnetic field does not interfere with other surrounding electronic components.

Further, the outer surface 12 of each of the two flat substrates 1 is formed of a copper foil layer. After formation of the designed circuit layout, the copper foil layer of the outer surface 12 of each of the two flat substrates 1 is coated with an insulative resin layer, and then coated with a layer of green color photosensitive lacquer by means of screen printing, curtain coating or electrostatic spraying techniques, and then heat dried and then cooled down, and then radiated by ultraviolet rays in an UV exposure machine under the use of a patterned mask to polymerize the green color photosensitive lacquer. After polymerization of the green color photosensitive lacquer at the outer surface 12 of each of the two flat substrates 1, apply sodium carbonate solution to remove the part of the coating that is not radiated by the ultraviolet rays. Thereafter, apply a high temperature heating process to cure the resin in the green color photosensitive lacquer. Thus, the circuit layout in the outer surface 12 of each of the two flat substrates 1 is well protected against oxidation or accidental short circuit during welding.

In conclusion, the invention provides an inductor comprising two flat substrates 1 each having opposing inner surface 11 and outer surface 12, a set of metal wire conductors 111 radially arranged at the center area of the inner surface 11 of each flat substrate 1 and a connection contact 111 at each of the opposing ends of each of the metal wire conductors 111, a solder material 113 electrically and alternatively connecting the connection contacts 112 of the metal wire conductors 111 at the inner surface 11 of each of the flat substrates 1 into two series to have an induction zone 13 be defined between the two flat substrates 1 corresponding to the metal wire conductors 111, and a metal core 2 set in the induction zone 13 between the two flat substrates 1 and adhered to the radially arranged metal wire conductors 111 with an adhesive 21 to provide a continuous winding type metal magnetic coil inductive effect for filtering, rectifying and chocking functions, avoiding interference. Thus, the inductor has the characteristics of low profile, excellent induction and current rectification ability

During application, the inductor of the invention has the advantages and features as follows:

By means of setting the metal core 2 between the two flat substrates to form the desired inductor, the inductor has a low profile characteristic practical for in an electronic product having light, thin, short and small characteristics.

The metal core 2 is set between the radially arranged metal wire conductors 111 at the inner surface 11 of each of the flat substrates 1 within the induction zone 13 and bonded thereto with an adhesive 21 to provide a continuous winding type metal magnetic coil inductive effect, eliminating the complicated winding procedure in the fabrication of a prior art inductor using an enabled wire winding technique.

The inductor has low profile and small size characteristics. Thus, when a magnetic field is induced upon conduction of electric current through the respective metal wire conductors 111, connection contacts 112 and solder material 113 and the induction zone 13, the induced magnetic field does not interfere with surrounding electronic components, enhancing high performance of the connected circuit board in current or signal transmission or current rectification.

Subject to the arrangement of the metal wire conductors 111 and the metal core 2 to provide a continuous winding type metal magnetic coil inductive effect, the inductor eliminates the drawback of complicated winding procedure in the fabrication of a prior art inductor using an enabled wire winding technique, thereby lowering the manufacturing cost.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A low-profile inductor, comprising:
two symmetric flat substrates arranged in parallel, each said flat substrate comprising opposing inner surface and outer surface, a set of metal wire conductors radially arranged in said inner surface, a connection contact located on each of two distal ends of each of said metal wire conductors and a circuit layout arranged in said outer surface;
a solder material set in between said flat substrates to electrically connect the metal wire conductors of said flat substrates in two series; and
a metal core bonded to the inner surface of each said flat substrate by an adhesive and set between the metal wire conductors at each of said two flat substrates such that an induction zone is defined between said flat substrates corresponding to the respective set of metal wire conductors to provide a continuous winding type metal magnetic coil inductive effect.

2. The low-profile inductor as claimed in claim 1, wherein said flat substrates are printed circuit boards or flexible circuit boards, each carrying a circuit layout at the respective outer surface.

3. The low-profile inductor as claimed in claim 2, wherein each said flat substrate comprises a plurality of metal input contacts and metal output contacts arranged in the outer surface thereof and electrically connected to said circuit layout; the two series of the electrically connected metal wire conductors and connection contacts at each said flat substrate are extended out of said induction zone and respectively electrically connected between said metal input contacts and said metal output contacts.

4. The low-profile inductor as claimed in claim 1, wherein said metal core is selected from the group of iron based, iron-nickel based and cobalt based non-crystalline alloys and iron based bulk nanocrystalline alloy, and made in one of the shapes of annular, rectangular, polygonal and multilateral open frames.

5. The low-profile inductor as claimed in claim 1, wherein said adhesive is selected from the group of polymer adhesive, plastic resin glue, chloroprene phenolic adhesive and quick dry adhesive.

6. A low-profile inductor fabrication method, comprising the steps of:
(i) preparing two flat substrates each having opposing inner surface and outer surface, and then employing a process to form metal wire conductors in the inner surface of each said flat substrate subject to a predetermined radially extended pattern and to form a circuit layout in the outer surface of each said flat substrate subject to a predetermined circuit layout pattern;
(ii) forming a connection contact at each of two distal ends of each of the metal wire conductors at each said flat substrate;
(iii) preparing a metal core, and then applying an adhesive to adhere two opposing sides of said metal core to the inner surfaces of said two flat substrates between the metal wire conductors at the inner surface of each said flat substrates and between the two connection contacts at each said metal wire conductor;
(iv) applying a solder material to the connection contacts at said metal wire conductors to electrically connect the metal wire conductors at one said flat substrate with the metal wire conductors at the other said flat substrate into two series, enabling the metal wire conductors to provide a continuous winding type metal magnetic coil inductive effect; and
(v) after bonding of the metal wire conductors at one said flat substrate with the metal wire conductors at the other said flat substrate, said flat substrates, said metal wire conductors, said solder material and said metal core constitute an inductor.

7. The low-profile inductor fabrication method as claimed in claim 6, wherein the metal wire conductors at said two flat substrates define an induction zone for providing a continuous winding type metal magnetic coil inductive effect.

8. The low-profile inductor fabrication method as claimed in claim 7, wherein each said flat substrate defines opposing input side and output side at the outer surface thereof opposite to said induction zone.

9. The low-profile inductor fabrication method as claimed in claim 6, wherein said metal core is selected from the group of iron based, iron-nickel based and cobalt based non-crystalline alloys and iron based bulk nanocrystalline alloy, and made in one of the shapes of annular, rectangular, polygonal and multilateral open frames.

10. The low-profile inductor fabrication method as claimed in claim 6, wherein said adhesive is selected from the group of polymer adhesive, plastic resin glue, chloroprene phenolic adhesive and quick dry adhesive.
